(19) United States
(12) Patent Application Publication
(10) Pub. No.: US 2021/0256308 A1
(43) Pub. Date: Aug. 19, 2021

(54) PARAMETER UPDATE APPARATUS, CLASSIFICATION APPARATUS, RECORDING MEDIUM, AND PARAMETER UPDATE METHOD

(71) Applicant: SCREEN HOLDINGS CO., LTD., Kyoto (JP)

(72) Inventors: Manri Terada, Kyoto (JP); Kiyotaka KASUBUCHI, Kyoto (JP); Kiyotaka MIYAI, Kyoto (JP); Akiko YOSHIDA, Kyoto (JP); Kazuhiro KITAMURA, Kyoto (JP); Koki UMEHARA, Kyoto (JP); Yuki SUMIYA, Kyoto (JP)

(21) Appl. No.: 17/167,326

(22) Filed: Feb. 4, 2021

(30) Foreign Application Priority Data
Feb. 14, 2020 (JP) 2020-023047

(51) Int. Cl. G06K 9/62; G06N 3/08; G06F 17/18

(52) U.S. Cl. CPC G06K 9/6256; G06K 9/6228; G06F 17/18; G06N 3/08; G06K 9/6268

(57) ABSTRACT

A parameter update apparatus according to the present invention includes: an input unit configured to receive input of teaching data; and an update unit configured to update a parameter for assigning at least one estimation label corresponding to each of a plurality of data items by performing multi-task learning by using a neural network for the plurality of data items of the input teaching data. The update unit updates the parameter so that a sum of errors between the assigned estimation label and a corresponding true label in the teaching data in the plurality of data items has a minimum value. Therefore, the plurality of data items constituting a hierarchical structure can be classified while preventing deterioration of classification accuracy.

### BACKGROUND OF THE INVENTION

### Field of the Invention

Technology disclosed in the specification of the present application relates to a parameter update apparatus, a classification apparatus, a parameter update program, and a parameter update method.

### Description of the Background Art

There has hitherto been a technology of classifying a plurality of data items, such as words in document data, by estimating and assigning an appropriate label for such data items.

In addition, a technology of updating a parameter for appropriately estimating the label has hitherto been used as well (see, for example, Japanese Patent Application Laid-Open No. 2016-162198).

When a plurality of input data items constitute a hierarchical structure, specifically, when at least a part of combinations is restricted (prohibited) between the data items, there is a problem that undesired inclusion of the combination of data items restricted in the hierarchical structure in estimation results of the classification may lead to deterioration of classification accuracy.

### SUMMARY OF THE INVENTION

The present invention is intended for a parameter update apparatus, a classification apparatus, a recording medium, and a parameter update method.

One aspect of the present invention is a parameter update apparatus including: an input unit configured to receive input of teaching data including a plurality of data items constituting a hierarchical structure and a true label corresponding to each of the plurality of data items; and an update unit configured to update a parameter for assigning at least one estimation label corresponding to each of the plurality of data items by performing multi-task learning by using a neural network for the plurality of data items of the input teaching data. The update unit updates the parameter so that a sum of errors between the assigned at least one estimation label and the corresponding true label in the teaching data in the plurality of data items has a minimum value.

Owing to the update unit updating the parameter so that the sum of the errors between the assigned estimation label and the true label in the plurality of data items has a minimum value, the use of the parameter enables assignment of the estimation labels in consideration of the hierarchical structure between the plurality of data items. As a result, deterioration of classification accuracy can be prevented.

One aspect of the present invention is a classification apparatus including a label assignment unit configured to assign the at least one estimation label corresponding to each of the plurality of input data items according to the parameter updated by the update unit in the above-described parameter update apparatus.

Owing to the update unit updating the parameter so that the sum of the errors between the assigned estimation label and the true label in the plurality of data items has a minimum value, the use of the parameter enables assignment of the estimation labels in consideration of the hierarchical structure between the plurality of data items. As a result, deterioration of classification accuracy can be prevented.

One aspect of the present invention is a recording medium storing a parameter update program. When the parameter update program is installed and executed by a computer, the recording medium is configured to implement causing the computer to update a parameter for assigning at least one estimation label corresponding to each of a plurality of data items by causing the computer to perform multi-task learning by using a neural network for the plurality of data items of teaching data including the plurality of data items constituting a hierarchical structure and a true label corresponding to each of the plurality of data items. The updating the parameter is updating the parameter so that a sum of errors between the assigned at least one estimation label and the corresponding true label in the teaching data in the plurality of data items has a minimum value.

Owing to the updating the parameter so that the sum of the errors between the assigned estimation label and the true label in the plurality of data items has a minimum value, the use of the parameter enables assignment of the estimation labels in consideration of the hierarchical structure between the plurality of data items. As a result, deterioration of classification accuracy can be prevented.

One aspect of the present invention is a parameter update method including: inputting teaching data including a plurality of data items constituting a hierarchical structure and a true label corresponding to each of the plurality of data items; and updating a parameter for assigning at least one estimation label corresponding to each of the plurality of data items by performing multi-task learning by using a neural network for the plurality of data items of the input teaching data. The updating the parameter is updating the parameter so that a sum of errors between the assigned at least one estimation label and the corresponding true label in the teaching data in the plurality of data items has a minimum value.

Owing to the updating the parameter so that the sum of the errors between the assigned estimation label and the true label in the plurality of data items has a minimum value, the use of the parameter enables assignment of the estimation labels in consideration of the hierarchical structure between the plurality of data items. As a result, deterioration of classification accuracy can be prevented.

Therefore, the object of the present invention is to classify a plurality of data items constituting a hierarchical structure while preventing deterioration of classification accuracy.

These and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram illustrating an example of a hardware configuration of a parameter update apparatus according to an embodiment.

FIG. 2 is a diagram illustrating an example of a functional configuration of the parameter update apparatus according to the embodiment.

FIG. 3 is a diagram illustrating an example of a functional configuration of a classification apparatus according to the embodiment.

FIG. 4 is a flowchart illustrating an example of parameter update operation.

FIG. 5 is a diagram illustrating an example of a plurality of data items constituting a hierarchical structure.

FIG. 6 is a diagram conceptually illustrating multi-task learning performed by using a neural network.

FIG. 7 is a flowchart illustrating an example of a procedure of multi-task learning performed by using a neural network.

FIG. 8 is a flowchart illustrating an example of classification operation.

FIG. 9 is a diagram illustrating a plurality of estimation labels estimated regarding the first data item and estimated probability corresponding to each of the estimation labels.

FIG. 10 is a diagram illustrating an example of calculated certainty.

FIG. 11 is a diagram illustrating five of a plurality of combinations illustrated in FIG. 10 in descending order from the combination having the highest certainty.

### DESCRIPTION OF THE PREFERRED EMBODIMENTS

An embodiment will be described below with reference to the attached drawings. The following embodiment will also describe detailed features and the like for the sake of description of technology, but those are merely an example, and all of those are not necessarily essential features to carry out the embodiment.

Note that the drawings are schematically illustrated, and for the sake of convenience of description, the configurations are omitted or the configurations are simplified in the drawings as appropriate. Further, the interrelationship of the size and the position between the configurations and the like illustrated in each of different drawings is not necessarily illustrated accurately, and may be changed as appropriate. Further, in the drawings such as plan views as well as cross-sectional views, hatching may be provided for the sake of easy understanding of the details of the embodiment.

Further, in the description illustrated below, similar components are denoted by the same reference signs in illustration, and are also given similar terms and functions. Thus, detailed description thereof may be omitted in order to avoid redundancy.

Further, in the following description, when the expressions such as “provide”, “include”, and “have” are used to describe a certain component, unless otherwise specifically noted, the expressions are not construed as exclusive expression that may exclude the presence of other components.

Further, in the following description, also when the ordinal numbers such as “first” and “second” are used as well, these terms are used for the sake of convenience of easy understanding of the details of the embodiment, and the order and the like that may be defined by these ordinal numbers are not restrictive.

### Embodiment

A parameter update apparatus, a classification apparatus, a parameter update program, and a parameter update method according to the present embodiment will be described below.

### Configuration of Parameter Update Apparatus

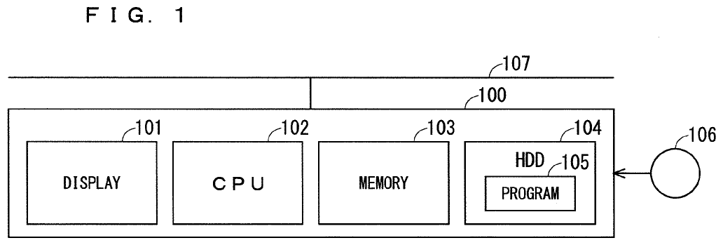

FIG. 1 is a diagram illustrating an example of a hardware configuration of a parameter update apparatus 100 according to the present embodiment.

As illustrated in FIG. 1, the parameter update apparatus 100 is at least a computer in which a program 105 that is used for update operation for a parameter is installed, and includes a central processing unit (specifically, CPU) 102, a memory 103, a hard disk drive (specifically, HDD) 104, and a display 101.

In the parameter update apparatus 100, a corresponding program 105 is installed in the HDD 104. The installation of the program 105 may be performed by writing into the HDD 104 data that is read from an external storage medium 106 such as a compact disc (specifically, CD), a digital versatile disc (specifically, DVD), and a universal serial bus (specifically, USB) memory, or may be performed by writing into the HDD 104 data that is received via a network 107.

Further, the HDD 104 may be replaced with an auxiliary storage apparatus of another type. For example, the HDD 104 may be replaced with a solid state drive (specifically, SSD), a random access memory (specifically, RAM) disk, or the like.

In the parameter update apparatus 100, the program 105 installed in the HDD 104 is loaded into the memory 103, and the loaded program 105 is executed by the CPU 102. In this manner, the computer executes the program 105 and thereby functions as the parameter update apparatus 100.

Note that at least a part of the processing performed by the CPU 102 may be performed by a processor other than the CPU 102. For example, at least a part of the processing performed by the CPU 102 may be performed by a graphics processing unit (GPU) or the like. Further, at least a part of the processing performed by the CPU 102 may be performed by hardware that does not execute the program.

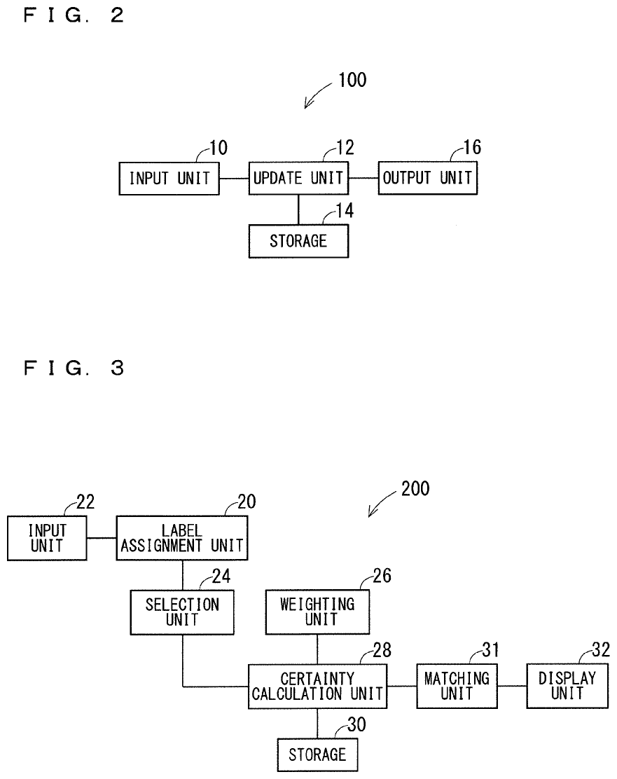

FIG. 2 is a diagram illustrating an example of a functional configuration of the parameter update apparatus 100 according to the present embodiment.

As illustrated in FIG. 2, the parameter update apparatus 100 at least includes an input unit 10 and an update unit 12. Further, the parameter update apparatus 100 may include a storage 14 and an output unit 16. The input unit 10 and the output unit 16 are implemented by the display 101 of FIG. 1 or the like. Further, the storage 14 is, for example, implemented by at least one of the memory 103 and the HDD 104 of FIG. 1. Further, the update unit 12 is, for example, implemented by causing the CPU 102 of FIG. 1 to execute the program 105.

The input unit 10 receives input of teaching data including data sets each including a plurality of data items constituting a hierarchical structure and true labels corresponding to each of the data items.

Here, the true label is a label to be assigned for each of the data items, and is a label determined in advance by a user or the like. The label is used to classify corresponding data items.

The update unit 12 performs multi-task learning by using a neural network regarding the plurality of data items of the input teaching data. In this manner, a parameter for assigning at least one estimation label corresponding to each of the data items is updated. The updated parameter is stored in the storage 14.

Here, the estimation label is estimation results of a label to be assigned for a data item output via the neural network. The label is used to classify corresponding data items.

### Configuration of Classification Apparatus

A hardware configuration of the classification apparatus is the same as the configuration of the parameter update apparatus 100 illustrated in FIG. 1. Specifically, the hardware configuration illustrated in FIG. 1 is a hardware configuration of the parameter update apparatus at the learning stage for updating parameters, and is a hardware configuration of the classification apparatus at the use stage.

FIG. 3 is a diagram illustrating an example of a functional configuration of the classification apparatus 200 according to the present embodiment. As illustrated in FIG. 3, the classification apparatus 200 at least includes a label assignment unit 20. Further, the classification apparatus 200 may include an input unit 22, a selection unit 24, a weighting unit 26, a certainty calculation unit 28, a storage 30, a matching unit 31, and a display unit 32.

The input unit 22 and the display unit 32 are implemented by the display 101 of FIG. 1 or the like. Further, the storage 30 is, for example, implemented by at least one of the memory 103 and the HDD 104 of FIG. 1. Further, the label assignment unit 20, the selection unit 24, the weighting unit 26, the matching unit 31, and the certainty calculation unit 28 are, for example, implemented by causing the CPU 102 of FIG. 1 to execute a corresponding to program 105.

The input unit 22 receives data sets each including a plurality of data items constituting a hierarchical structure with each other. The label assignment unit 20 assigns at least one estimation label corresponding to each of the input data items, according to the parameter updated in the parameter update apparatus 100.

The selection unit 24 selects at least one estimation label out of a plurality of estimation labels corresponding to each of the data items in descending order from the estimation label having the highest estimated probability. Here, the estimated probability is a value indicating probability that a corresponding estimation label is a true label. The weighting unit 26 sets a weight for each of the data items. Here, the value of the weight for each of the data items is set in advance by a user or the like.

The certainty calculation unit 28 calculates certainty of combinations between the estimation labels corresponding to each of the plurality of data items, based on the weight. The certainty will be described later. The matching unit 31 checks whether or not there is a restricted combination between the plurality of data items constituting the hierarchical structure, regarding each of the combinations whose certainty has been calculated. The display unit 32 displays a plurality of combinations whose certainty has been calculated.

### Operation of Parameter Update Apparatus

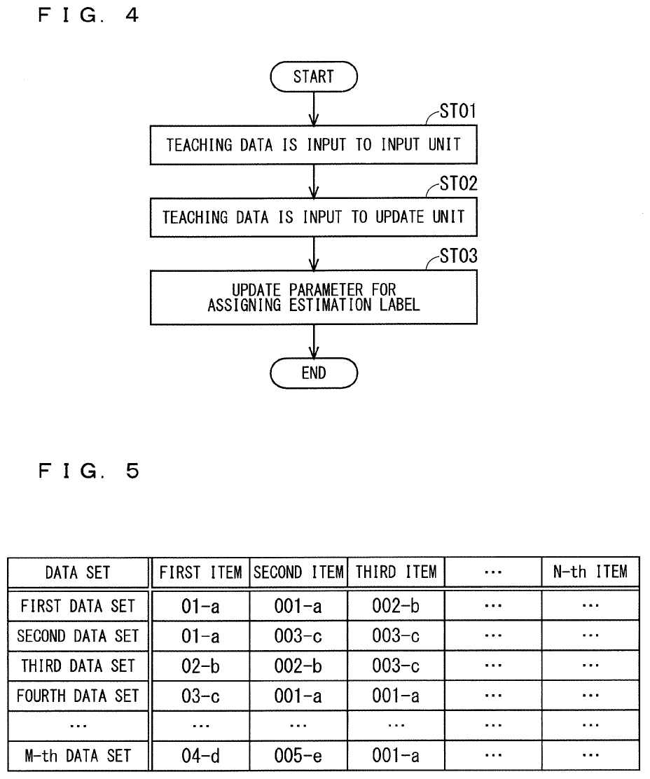

Next, operation of the parameter update apparatus 100 will be described with reference to FIG. 4 to FIG. 7. Note that FIG. 4 is a flowchart illustrating an example of parameter update operation.

First, teaching data including data sets each including a plurality of data items constituting a hierarchical structure with each other and true labels corresponding to each of the data items is input to the input unit 10 (Step ST01 of FIG. 4). Note that the data set is, for example, text data, image data, or the like.

Here, the plurality of data items constituting a hierarchical structure are data items in which at least a part of combinations is restricted between the data items. FIG. 5 is a diagram illustrating an example of a plurality of data items constituting a hierarchical structure. Note that when “the hierarchical structure is constituted”, ones without a relationship of a generic concept and a specific concept (master-servant relationship) between the data items are included as well.

As illustrated in FIG. 5, for example, the data set is as follows: in a case where one data set (for example, the first data set) includes three data items (the first data item, the second data item, and the third data item), when the value of the first data item (for example, 01-a) is determined, the value of the second data item (001-a) is determined based on the value of the first data item (01-a), and further, when the value of the second data item (001-a) is determined, the value of the third data item (002-b) is determined based on the value of the second data item (001-a), and there are impossible combinations between the data items of each data set.

Next, the teaching data input to the input unit 10 is subjected to pre-processing required as appropriate, and is then input to the update unit 12 (Step ST02 of FIG. 4). Here, the pre-processing is, for example, processing of dividing into words, processing of removing noise such as an html tag and a line break, or the like.

Next, the update unit 12 performs multi-task learning by using the neural network, based on the input teaching data. In this manner, a parameter for assigning an estimation label corresponding to each of the data items is updated (Step ST03 of FIG. 4).

Specifically, a loss function is configured so that the sum of distances (errors) between the estimation label and the true label in the plurality of data items (the sum of cross entropies) has a minimum value regarding assignment of the estimation label for each of the data items corresponding to a plurality of tasks. Then, the update unit 12 sequentially learns the plurality of data sets, and updates the parameter for assigning the estimation label.

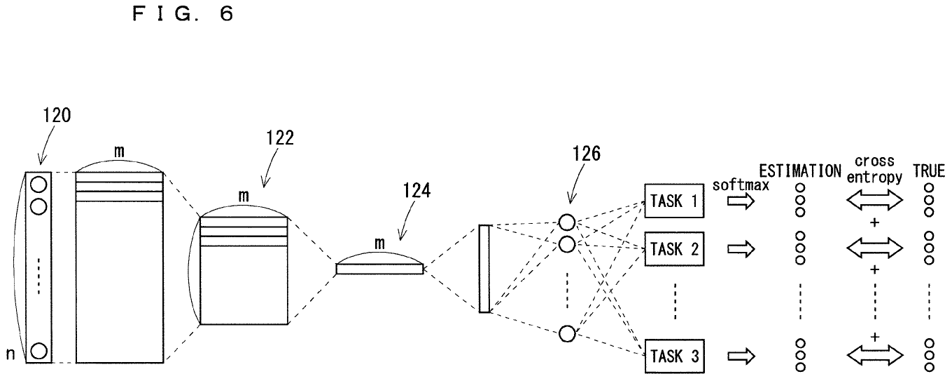

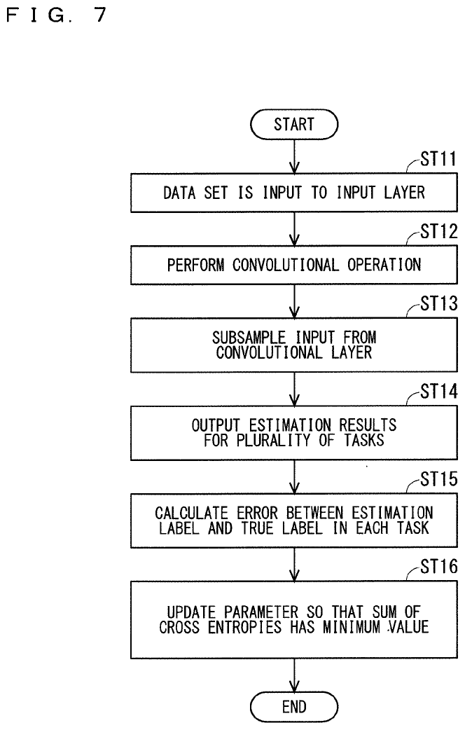

FIG. 6 is a diagram conceptually illustrating multi-task learning performed by using the neural network. In the present embodiment, multi-task learning is performed by using a convolutional neural network including a convolutional layer. Further, FIG. 7 is a flowchart illustrating an example of a procedure of multi-task learning performed by using the neural network.

As illustrated in FIG. 6, in an input layer 120, a data set including a plurality of data items (for example, N data items) constituting a hierarchical structure with each other is input (Step ST11 of FIG. 7). Then, an ID is assigned so that a word and an ID are uniquely determined for all of the words included in the data set (for example, n words). Further, each word is converted (embedding: word embedding) into a specific vector (for example, an m-dimensional one-hot vector).

Next, in a convolutional layer 122, a linear sum of a parameter and a bias value is calculated (convolutional operation) for a part of the input from the input layer 120, and the calculation results are output to a pooling layer 124 (Step ST12 of FIG. 7). The parameter used herein is, for example, a parameter that is learned with the error back propagation method or the like to be updated.

Next, in the pooling layer 124, the input from the convolutional layer 122 is subsampled. Specifically, downsampling is performed by lowering resolution of a feature map (Step ST13 of FIG. 7). Here, maximum value sampling is performed.

Next, in a full merge layer 126, a linear sum of a parameter and a bias value is calculated for all of the input from the pooling layer 124, and estimation results (identification results of the estimation label) for the plurality of tasks are output based on calculation results (Step ST14 of FIG. 7). The parameter used herein is, for example, a parameter that is learned with an error back propagation method or the like to be updated.

Then, the output estimation results are converted into estimated probability by using a softmax function being an activation function, and an error (cross entropy) between the estimation label and the true label in each of the tasks (specifically, assignment of the estimation label in each data item) is calculated (Step ST15 of FIG. 7).

Then, the parameter in the convolutional layer 122 and the full merge layer 126 is learned with, for example, the error back propagation method or the like to be updated, so that the sum of the cross entropies for the plurality of tasks has a minimum value (Step ST16 of FIG. 7).

### Operation of Classification Apparatus

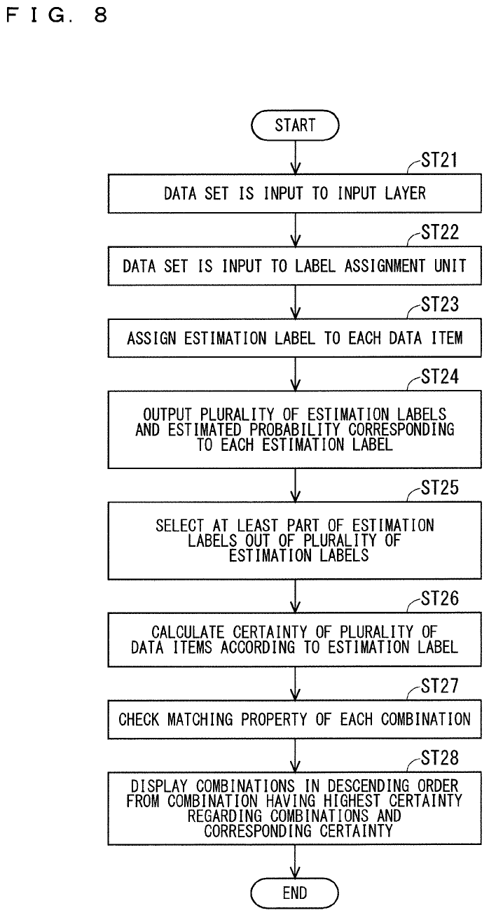

Operation of the classification apparatus 200 will be described with reference to FIG. 8 to FIG. 11. Note that FIG. 8 is a flowchart illustrating an example of classification operation.

The classification apparatus 200 classifies each of the data items in the input data set by using the neural network in which the parameter updated by the parameter update apparatus 100 is configured.

First, a data set including a plurality of data items constituting a hierarchical structure with each other is input to the input unit 22 (Step ST21 of FIG. 8). Then, the data set is subjected to pre-processing required as appropriate, and is then input to the label assignment unit 20 (Step ST22 of FIG. 8).

Next, the label assignment unit 20 assigns at least one estimation label to each of the data items in the input data set by using the neural network in which the parameter updated by the parameter update apparatus 100 is configured (Step ST23 of FIG. 8). Note that one estimation label may be assigned to each of the data items. In the present embodiment, however, a plurality of estimation labels are assigned for one data item.

Then, the label assignment unit 20 outputs the plurality of estimation labels assigned to each of the data items and the estimated probability corresponding to each of the estimation labels (Step ST24 of FIG. 8).

Next, the selection unit 24 selects at least a part of the estimation labels out of the plurality of estimation labels corresponding to each of the data items output from the label assignment unit 20 (Step ST25 of FIG. 8).

For example, the selection unit 24 selects the estimation labels in descending order from the estimation label having the highest estimated probability, and stops the selection at the time point when the sum of the estimated probabilities exceeds a threshold. Alternatively, the selection unit 24 selects the estimation labels in descending order from the estimation label having the highest estimated probability, and stops the selection at the time point when the number of selected estimation labels exceeds a threshold. Here, the threshold is set in advance by a user or the like.

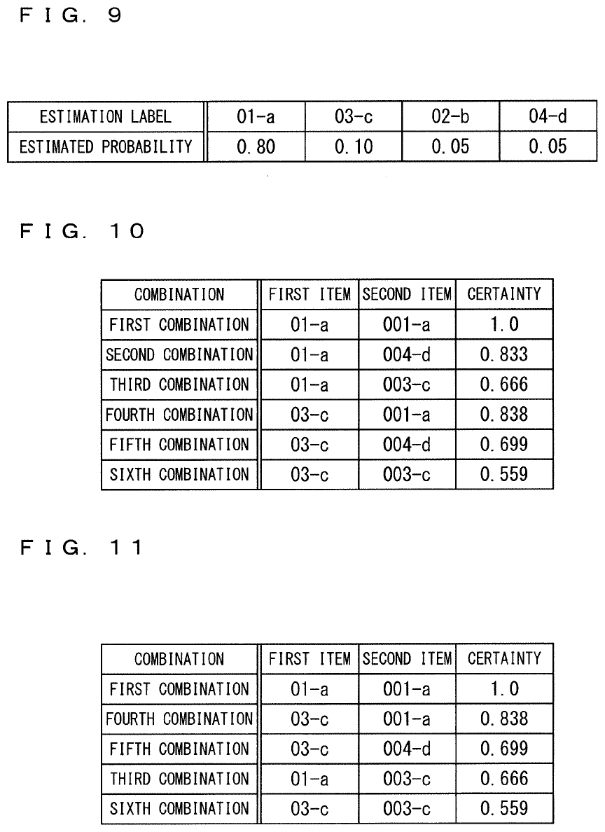

FIG. 9 is a diagram illustrating a plurality of estimation labels estimated regarding the first data item and the estimated probability corresponding to each of the estimation labels.

In the case of FIG. 9, the selection unit 24 selects the estimation labels in descending order from the estimation label having the highest estimated probability, e.g., selects the estimation labels in order of 01-a, 03-c, and 02-b, and stops the selection of the estimation labels at the time point (selection time point of 02-b) when the sum of the estimated probabilities exceeds a threshold (for example, 0.9).

Alternatively, the selection unit 24 selects the estimation labels in descending order from the estimation label having the highest estimated probability, e.g., selects the estimation labels in order of 01-a, 03-c, 02-b, and 04-d, and stops the selection at the time point (selection time point of 02-b) when the number of selected estimation labels exceeds a threshold (for example, 2).

Note that, regarding the number of selected estimation labels, in order to prevent accuracy from being 0 when the estimation label having the highest estimated probability is not a true label, for example, the number of selected estimation labels can be set to 2 or greater.

After the selection unit 24 has selected a plurality of estimation labels regarding all of the data items, the certainty calculation unit 28 calculates weighted simultaneous probability (referred to as certainty) of the plurality of data items according to the estimation labels (Step ST26 of FIG. 8). Then, the calculated certainty is stored in the storage 30. Here, the simultaneous probability is probability that combinations of a plurality of data items according to the estimation labels are generated (probability that a plurality of estimation labels are generated simultaneously).

To calculate the certainty, the certainty calculation unit 28 acquires the weight corresponding to each of the data items configured in advance in the weighting unit 26. Note that the certainty calculation unit 28 may calculate simple simultaneous probability of the plurality of data items as the certainty without acquiring the weight from the weighting unit 26.

Here, the certainty is obtained according to the following expression (1).

$$CERTAINTY = \frac{\begin{matrix}WEIGHTED SIMULTANEOUS PROBABILITY - \\ OVERALL MINIMUM SIMULTANEOUS PROBABILITY\end{matrix}}{\begin{matrix}WEIGHTED OVERALL MAXIMUM \\ SIMULTANEOUS PROBABILITY - \\ OVERALL MINIMUM SIMULTANEOUS PROBABILITY\end{matrix}} \qquad ( 1 )$$

Further, the weighted simultaneous probability is obtained according to the following expression (2).

$$\begin{matrix}WEIGHTED \\ SIMULTANEOUS \\ PROBABILITY\end{matrix} = \{ ( \frac{log ( ESTIMATION PROBABILITY OF FIRST ITEM )}{( log ( WEIGHT OF FIRST ITEM ) + 1 )} ) \times ( \frac{log ( ESTIMATION PROBABILITY OF SECOND ITEM )}{( log ( WEIGHT OF SECOND ITEM ) + 1 )} ) \times ( \frac{log ( ESTIMATION PROBABILITY OF N \text{-} th ITEM )}{( log ( WEIGHT OF N \text{-} th ITEM ) + 1 )} ) \qquad ( 2 )$$

Further, the weighted overall maximum simultaneous probability is obtained according to the following expression (3).

WEIGHTED OVERALL MAXIMUM SIMULTANEOUS PROBABILITY=max(SET OF WEIGHTED SIMULTANEOUS PROBABILITIES) (3)

Further, the overall minimum simultaneous probability is obtained according to the following expression (4).

OVERALL MINIMUM SIMULTANEOUS PROBABILITY=min(SET OF SIMULTANEOUS PROBABILITIES) (4)

FIG. 10 is a diagram illustrating an example of the calculated certainty. In the case illustrated in FIG. 10, estimation labels 01-a and 03-c are selected for the first item and estimation labels 001-a, 004-d, and 003-c are selected for the second item, and as combinations thereof, certainty is calculated for each of the first combination, the second combination, the third combination, the fourth combination, the fifth combination, and the sixth combination.

Next, the matching unit 31 checks matching property of each of the combinations whose certainty has been calculated (Step ST27 of FIG. 8). Specifically, whether or not there is a restricted (prohibited) combination between the plurality of data items constituting the hierarchical structure is checked. Then, if there is a restricted combination, the restricted combination is eliminated from candidates of combinations to be displayed in the display unit 32.

Next, the display unit 32 displays the combinations in descending order from the combination having the highest certainty, regarding the combinations having matching property and corresponding certainty (Step ST28 of FIG. 8).

FIG. 11 is a diagram illustrating five of the plurality of combinations illustrated in FIG. 10 in descending order from the combination having the highest certainty. In the example of FIG. 11, the combinations are displayed in descending order from the combination having the highest certainty, with five combinations having matching property out of the six combinations illustrated in FIG. 10 being selected and one combination not having matching property being eliminated.

In this manner, the combinations of the plurality of data items are displayed in descending order from the combination having the highest certainty, and therefore the probability that the combination with the true label is included in these combinations can be increased in consideration of the hierarchical structure.

### Effects Produced by Above-Described Embodiment

Next, an example of effects produced by the above-described embodiment will be described. Note that the following will describe the effects based on a specific configuration illustrated in the above-described embodiment. Such a specific configuration, however, may be replaced with another specific configuration illustrated in the specification of the present application in so far as similar effects are produced.

According to the above-described embodiment, the parameter update apparatus includes an input unit 10 and an update unit 12. The input unit 10 receives input of teaching data including a plurality of data items constituting a hierarchical structure and a true label corresponding to each of the data items. The update unit 12 updates a parameter for assigning at least one estimation label corresponding to each of the data items by performing multi-task learning by using a neural network for the plurality of data items of the input teaching data. Further, the update unit 12 updates the parameter so that the sum of errors between the assigned estimation label and the corresponding true label in the teaching data in the plurality of data items has a minimum value.

According to the configuration as described above, owing to the update unit 12 updating the parameter so that the sum of the errors between the assigned estimation label and the true label in the plurality of data items has a minimum value, the use of the parameter enables assignment of the estimation labels in consideration of the hierarchical structure between the plurality of data items. Therefore, the probability that the estimation label corresponding to a combination restricted (prohibited) between the plurality of data items is assigned can be reduced. As a result, deterioration of classification accuracy can be prevented.

Note that similar effects can be produced even when another configuration illustrated in the specification of the present application is added to the above-described configuration as appropriate, specifically, even when another configuration in the specification of the present application not referred to as the above-described configuration is added as appropriate.

Further, according to the above-described embodiment, the classification apparatus 200 includes the label assignment unit 20 that assigns at least one estimation label corresponding to each of the input data items according to the parameter updated by the update unit 12 in the parameter update apparatus 100. According to the configuration as described above, by assigning the estimation label through the use of the updated parameter, the estimation label can be assigned to each of the data items in consideration of the hierarchical structure between the plurality of data items. Therefore, the probability that the estimation label corresponding to a combination restricted between the plurality of data items is assigned can be reduced. As a result, deterioration of classification accuracy can be prevented.

Further, according to the above-described embodiment, the label assignment unit 20 assigns the plurality of estimation labels corresponding to each of the data items. Further, the classification apparatus 200 includes the selection unit 24 that selects, out of the plurality of estimation labels corresponding to each of the data items, at least one estimation label in descending order from the estimation label having the highest estimated probability. According to the configuration as described above, the estimation labels are selected in descending order from the estimation label having the highest estimated probability, and thus the probability that the estimation label is a true label can be increased.

Further, according to the above-described embodiment, the selection unit 24 determines the number of estimation labels to be selected, based on the sum of the estimation probabilities of the estimation labels to be selected. According to the configuration as described above, a plurality of estimation labels are selected, and the probability that a true label is included in those estimation labels can be increased.

Further, according to the above-described embodiment, the selection unit 24 selects at least one estimation label so that the number of estimation labels to be selected falls within a predetermined range. According to the configuration as described above, while a plurality of estimation labels are selected, the estimation labels can be selected so as to prevent a calculation amount from being an extensive amount.

Further, according to the above-described embodiment, the classification apparatus 200 includes the weighting unit 26 that sets a weight for each of the data items, and the certainty calculation unit 28 that calculates certainty of combinations between the estimation labels corresponding to each of the plurality of data items, based on the weight. According to the configuration as described above, by setting the weight according to importance of each data item, the weighted simultaneous probability of the combinations of the estimation labels can be appropriately adjusted according to a specification.

Further, according to the above-described embodiment, the classification apparatus 200 includes the display unit 32 that displays a plurality of combinations in descending order from the combination having the highest certainty. According to the configuration as described above, by displaying a plurality of combinations of the plurality of estimation labels in descending order from the combination having its corresponding certainty being the highest, the probability that a combination of a true label is included in these combinations can be increased.

According to the above-described embodiment, when being installed and executed by a computer (the CPU 102 according to the present embodiment), the parameter update program causes the CPU 102 to update a parameter for assigning at least one estimation label corresponding to each of the data items by causing the CPU 102 to perform multi-task learning by using a neural network for the plurality of data items of teaching data including the plurality of data items constituting a hierarchical structure and a true label corresponding to each of the data items. Here, the updating the parameter is updating the parameter so that the sum of errors between the assigned estimation label and the corresponding true label in the teaching data in the plurality of data items has a minimum value.

According to the configuration as described above, owing to the updating the parameter so that the sum of the errors between the assigned estimation label and the true label in the plurality of data items has a minimum value, the use of the parameter enables assignment of the estimation labels in consideration of the hierarchical structure between the plurality of data items. Therefore, the probability that the estimation label corresponding to a combination restricted between the plurality of data items is assigned can be reduced. As a result, deterioration of classification accuracy can be prevented.

Note that the above-described program may be stored in a computer-readable portable recording medium, such as a magnetic disk, a flexible disk, an optical disc, a compact disc, a Blu-ray (registered trademark) disc, and a DVD. Further, the portable recording medium storing the program for implementing the above-described function may be commercially distributed.

According to the above-described embodiment, the parameter update method includes: inputting teaching data including a plurality of data items constituting a hierarchical structure and a true label corresponding to each of the data items; and updating a parameter for assigning at least one estimation label corresponding to each of the data items by performing multi-task learning by using a neural network for the plurality of data items of the input teaching data. Here, the updating the parameter is updating the parameter so that the sum of errors between the assigned estimation label and the corresponding true label in the teaching data in the plurality of data items has a minimum value.

According to the configuration as described above, owing to the updating the parameter so that the sum of the errors between the assigned estimation label and the true label in the plurality of data items has a minimum value, the use of the parameter enables assignment of the estimation labels in consideration of the hierarchical structure between the plurality of data items. Therefore, the probability that the estimation label corresponding to a combination restricted between the plurality of data items is assigned can be reduced. As a result, deterioration of classification accuracy can be prevented.

### Modifications of Above-Described Embodiment

In the above-described embodiment, the dimension, the shape, the relative disposition relationship, the condition for implementation, and the like of each component may be described. However, all of these are merely an example in all the aspects, and are not limited to those described in the specification of the present application.

Thus, numerous unillustrated modifications and equivalents are assumable within the scope of the technology disclosed in the specification of the present application. For example, a case in which at least one component is modified, added, or omitted is included.

Further, each component described in the above-described embodiment is assumed as software or firmware, or as hardware corresponding thereto. In both of the concepts, each component is referred to as a “unit”, a “processing circuit” (circuitry), or the like.

Note that, in the present invention, any component in the present embodiment can be modified or omitted within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A parameter update apparatus comprising:
an input unit configured to receive input of teaching data including a plurality of data items constituting a hierarchical structure and a true label corresponding to each of the plurality of data items; and
an update unit configured to update a parameter for assigning at least one estimation label corresponding to each of the plurality of data items by performing multi-task learning by using a neural network for the plurality of data items of the input teaching data, wherein
the update unit updates the parameter so that a sum of errors between the assigned at least one estimation label and the corresponding true label in the teaching data in the plurality of data items has a minimum value.

2. A classification apparatus comprising
a label assignment unit configured to assign the at least one estimation label corresponding to each of the plurality of input data items according to the parameter updated by the update unit in the parameter update apparatus according to claim 1.

3. The classification apparatus according to claim 2, wherein
the at least one estimation label includes a plurality of estimation labels,
the label assignment unit assigns the plurality of estimation labels corresponding to each of the plurality of data items, and
the classification apparatus further comprises a selection unit configured to select, out of the plurality of estimation labels corresponding to each of the plurality of data items, at least one of the plurality of estimation labels in descending order from one of the plurality of estimation labels having highest estimated probability.

4. The classification apparatus according to claim 3, wherein
the selection unit determines a number of the at least one of the plurality of estimation labels to be selected, based on a sum of the estimated probabilities of the least one of the plurality of estimation labels to be selected.

5. The classification apparatus according to claim 3, wherein
the selection unit selects the at least one of the plurality of estimation labels so that a number of the at least one of the plurality of estimation labels to be selected falls within a predetermined range.

6. The classification apparatus according to claim 2, further comprising:
a weighting unit configured to set a weight for each of the plurality of data items; and
a certainty calculation unit configured to calculate certainty of a combination between the plurality of estimation labels corresponding to each of the plurality of data items, based on the weight.

7. The classification apparatus according to claim 6, further comprising
a display unit configured to display a plurality of the combinations in descending order from one of the plurality of the combinations having the highest certainty.

8. A recording medium storing a parameter update program, when the parameter update program is installed and executed by a computer, the recording medium being configured to implement
causing the computer to update a parameter for assigning at least one estimation label corresponding to each of a plurality of data items by causing the computer to perform multi-task learning by using a neural network for the plurality of data items of teaching data including the plurality of data items constituting a hierarchical structure and a true label corresponding to each of the plurality of data items, wherein
the updating the parameter is updating the parameter so that a sum of errors between the assigned at least one estimation label and the corresponding true label in the teaching data in the plurality of data items has a minimum value.

9. A parameter update method comprising:
inputting teaching data including a plurality of data items constituting a hierarchical structure and a true label corresponding to each of the plurality of data items; and
updating a parameter for assigning at least one estimation label corresponding to each of the plurality of data items by performing multi-task learning by using a neural network for the plurality of data items of the input teaching data, wherein
the updating the parameter is updating the parameter so that a sum of errors between the assigned at least one estimation label and the corresponding true label in the teaching data in the plurality of data items has a minimum value.
